(19) United States
(12) Patent Application Publication
(10) Pub. No.: US 2009/0150229 A1
(43) Pub. Date: Jun. 11, 2009

(54) ANTI-COLLUSIVE VOTE WEIGHTING

(76) Inventor: Gary Stephen SHUSTER, Fresno, CA (US)

Correspondence Address: CONNOLLY BOVE LODGE & HUTZ LLP, P.O. BOX 2207, WILMINGTON, DE, 19899, US

(21) Appl. No.: 12/329,296

(22) Filed: Dec. 5, 2008

Related U.S. Application Data
(60) Provisional application No. 60/992,493, filed on Dec. 5, 2007.

(51) Int. Cl. G07C 11/00

(52) U.S. Cl. 705/12

(57) ABSTRACT

An anti-collusive vote weighting method and system. Instances of possible vote collusion may be identified based on correlating the vote history of users voting on an information item and weighting the votes in accordance with the correlated voting history. A list of information items may be compiled and ranked by the quantity of voting data received from a plurality of users. The vote histories of two or more users may be correlated to obtain a correlation value associated with the users. A lesser predetermined weight may be applied to the voting data of users having correlation values above a first predetermined value. In addition, a greater predetermined weight may be applied to the voting data of users having correlation values below a second predetermined value. The greater the correlation between vote histories of users, the greater the likelihood that the voters are colluding to vote for the information item.

### CROSS-REFERENCE TO RELATED APPLICATIONS

This application claims priority pursuant to 35 U.S.C. § 119(e) to U.S. provisional application Ser. No. 60/992,493, filed Dec. 5, 2007, which is hereby incorporated by reference, in its entirety.

### BACKGROUND

1. Field

The present technology relates to voting systems for online content, and in particular, to anti-collusive vote weighting for online content.

2. Description of Related Art

Web 2.0 describes the changing trend in the way that people have come to use the Internet. Instead of being a static repository of information, the Internet has now evolved into a more interactive platform, with the user becoming an active participant in the creation and delivery of content.

Examples of websites that embody Web 2.0 include www.wikipedia.org (“Wikipedia”) and www.digg.com (“Digg”). Wikipedia contains millions of articles which have been written collaboratively by users around the world and almost all of its articles may be edited by anyone who can access the Wikpedia website. Digg allows users to discover and share content from anywhere on the Internet by submitting links and stories, and voting and commenting on submitted links and stories. Voting stories up and down is Digg's cornerstone function. Many stores get submitted every day, but only those stories getting the highest votes appear on the front page.

The accessibility and interactivity of Web 2.0 type websites makes them susceptible to abuse by users. Content on Wikipedia is vulnerable to vandalism and the addition of spurious or unverified information. Users may collusively vote to boost rankings for stories so as to increase the visibility of such stories and make them appear more popular than they actually are. For example, during the 2008 presidential race, hundreds of supporters of Ron Paul colluded on Digg to vote for stories referencing Ron Paul in a positive light. Such collusion attempts to provide increased visibility to stories that may not be as inherently valuable or interesting to the general user base, thereby reducing usability or value of the website for other users.

It is therefore desirable to have a method and system to counter the effects of online voter collusion in collaborative content ranking and/or selection.

### SUMMARY

The present method and system provides for anti-collusive vote weighting. Vote collusion may exist on current online voting systems. The methods and systems disclosed herein provides a way of identifying instances of possible vote collusion based on correlating the voting history of users voting on an information item and weighting the votes in accordance with the correlated voting history.

In one embodiment, an anti-collusive vote weighting system is provided. The system comprises a network interface disposed to receive voting data from a plurality of users. The voting data pertains to specific information items, such as websites or stories which are accessible from the Internet. The system also comprises a database comprising vote histories for the users. The vote histories associate each user with voting data. A memory holds program instructions operable for compiling a list of information items ranked by the quantity of voting data received from the plurality of users above a predetermined threshold; identifying two or more information items having the same subject matter; correlating the vote histories of two or more users for each one of the information items to obtain a correlation value associated for each one of the two or more users; and assigning a lesser predetermined weight to the voting data of users having correlation values above a first predetermined value. A processor, in communication with the memory and the network interface, is configured for operating the program instructions.

In another embodiment, a computer-readable media is provided. The computer-readable media is encoded with instructions operative to cause a computer to perform the steps of: compiling a list of information items ranked by the quantity of voting data received from the plurality of users above a predetermined threshold; identifying two or more information items having the same subject matter; correlating the vote histories of two or more users for each one of the information items to obtain a correlation value associated for each one of the two or more users; and assigning a lesser predetermined weight to the voting data of users having correlation values above a first predetermined value.

In a further embodiment, an anti-collusive vote weighting system is provided. The system comprises a network interface disposed to receive voting data from a plurality of users, the voting data pertaining to specific information items. A database comprises vote histories for the users. The vote histories associate each user with voting data. A memory holds program instructions operable for: compiling a list of information items ranked by the quantity of voting data received from the plurality of users above a predetermined threshold; correlating the vote histories of two or more users for the information item to obtain a correlation value associated for each one of the two or more users; and assigning a lesser predetermined weight to the voting data of users having correlation values above a first predetermined value. A processor, in communication with the memory and the network interface, is configured for operating the program instructions.

A more complete understanding of the method and system for anti-collusive vote weighting will be afforded to those skilled in the art, as well as a realization of additional advantages and objects thereof, by a consideration of the following detailed description of the preferred embodiment. Reference will be made to the appended sheets of drawings, which will first be described briefly.

### BRIEF DESCRIPTION OF THE DRAWINGS

FIG. 1 is a flow diagram illustrating an embodiment of a method of anti-collusive vote weighting.

FIG. 2 is a block diagram illustrating an embodiment of an anti-collusive vote weighting system.

In the detailed description that follows, like element numerals are used to describe like elements appearing in one or more of the figures.

### DETAILED DESCRIPTION OF VARIOUS EMBODIMENTS

One of ordinary skill in the art will find that there are a variety of ways to design a client or server architecture to accomplish a defined method. Therefore, methods and systems within the inventive scope are not limited to the specific client or server architecture that is disclosed, and encompass variations and modifications embodying the inventive methods and systems disclosed herein.

The present system, apparatus and method provides for anti-collusive vote weighting which may take place on online voting systems, such as www.digg.com. Such collusion is possible using, for example, external tools such as email lists, and leads to increasing the rankings and visibility for stories or other electronic content that may not be as inherently valuable or interesting to the general user base of the website.

A group, for example, may collude to vote for any story casting the U.S. Patent and Trademark Office in a positive light. Such collusion may result in multiple stories on the same event simultaneously rising to the top of the online voting website list. If a new story about the U.S. Patent and Trademark Office is posted, Voter #1 may vote for the story and is counted as one vote. If Voter #2 votes for the story, and the system notes a 99% correlation between Voter #1 and Voter #2's vote history, Voter #2's vote may be counted as less than one. For example, Voter #2's vote may be counted as 25% of one vote. If Voter #3 votes for the story, and the system notes that Voter #3 has a 1% correlation with Voter #1 and Voter #23 s vote history, the system may count Voter #3's vote as 100% of one vote. Accordingly, the story may have 2.25 votes rather than 3 votes. Just as it is possible to reduce the weight of a vote, it may also be possible to boost the vote value for independent vote histories which have lower or no correlation with other vote histories. For example, if a voter has a vote history that does not correspond with any other voter's vote history above a predetermined threshold, that voter's vote may be given more weight in the vote count. One of ordinary skill in the art would recognize that the thresholds for reducing or boosting vote count and the amount reduced or boosted are subject to variation according to the needs of the website and the desired results.

In an aspect, the website may also present multiple versions of itself to the website user, allowing a user to choose from a default version or customized versions. Each user may be able to choose from a variety of weighting schemes in selecting the results displayed to them.

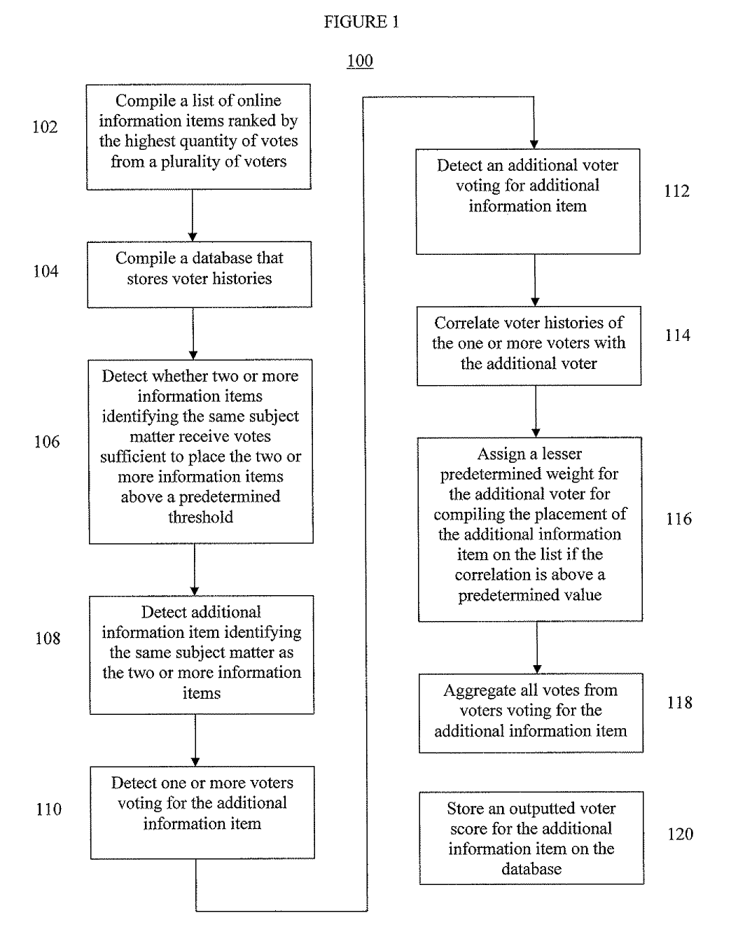

FIG. 1 is a flow diagram illustrating a method 100 of anti-collusive vote weighting in accordance with the present disclosure. Method 100 comprises a transformative process in which electronic content, and electronic input representing user votes, endorsements, or ratings for particular content items are received over time, compiled and processed to provide an ordered output of content items (e.g., a list, matrix, or ranking) for display at a client device. The ordered output is indicative of relative votes, endorsements or ratings received, and is weighted to diminish distortions of the ordered output caused by collaborative voting.

At 102, a processor enabled by a coded program compiles a list of online informational items ranked by the highest quantity of votes from a plurality of users. The votes signify a popularity quotient of the informational items in proportion to a relative quantity of votes received. For example, if an item receives a relatively high number of votes, the popularity quotient may be determined to be relatively high, as well; and conversely, a relatively low number of votes may determine a relatively low popularity quotient. The list may be pre-populated or may be compiled through user submissions. At 104, the processor records each vote received in a database that stores vote histories of the plurality of users. The vote histories document the votes associated with each one of the plurality of users.

At 106, the processor detects whether two or more information items identifying the same subject matter have received a sufficient quantity of votes to place the two or more information items above a predetermined threshold on the list. The predetermined threshold may consist of a rank, such as the Top 10, Top 50, Top 100 or any other ranking. One of ordinary skill in the art would recognize that the predetermined threshold may be chosen depending upon various factors and depends on the desired parameters of the method.

If the detection is made at 106, the processor may proceed to 108. At 108, the processor detects whether there is an additional information item identifying the same subject matter as the two or more information items. The processor may identify that the additional information item has the same subject matter by analyzing the title, contents or source. Analyzing the source may include determining whether the information item was originated with the Associated Press, for example, in a news story. The additional information items may be identified as a likely candidate for collusive voting because it is the same or has very similar contents to the two or more information items detected at 106.

At 110, the processor may detect whether there is one or more voters voting for the additional information item. This step identifies the possible voters that may be colluding to artificially enhance the additional information item's standing on the list of online information items. At 112, the processor may detect an additional voter voting for the additional information item. Steps 110 and 112 may also be performed synchronously such that all the potential voters voting for the additional information item may be identified. At 114, the processor correlates vote histories of the one or more voters with the additional voter. As above, each of the voters voting for the additional information item may be correlated at 114 so that every potential voter is compared against all other voters voting for the additional information item.

At 116, the processor assigns a lesser predetermined weight for the additional voter's vote for compiling the placement of the additional information item on the list of online information items if the correlation is above a predetermined value. The predetermined value, for example, may be a percentage value that signifies how many of the votes each of the compared voters has in common. The percentage value may be chosen depending on the system parameters and may vary with different applications.

At 118, the processor aggregates all votes from voters voting for the additional information item. This may be done continuously or periodically to update the list of online information items. In an aspect, the processor aggregates the votes every time a user votes for the additional information item.

At 120, the processor stores an outputted voter score for the additional information item on the database. The outputted voter score may consist of a number of votes for the additional information item. The outputted voter score may then be compiled and added to the list of online information items.

In an aspect, the method 100 may be adapted to assign a greater predetermined weight for voters having a correlation below a predetermined value. This essentially boosts, rather than reduces, the weight of the voter's vote. The website offering the ranking services may also offer multiple versions of the method 100. For example, the users may be provided with an option to choose from a variety of weighting schemes offered by the process engine for selecting the results displayed to them.

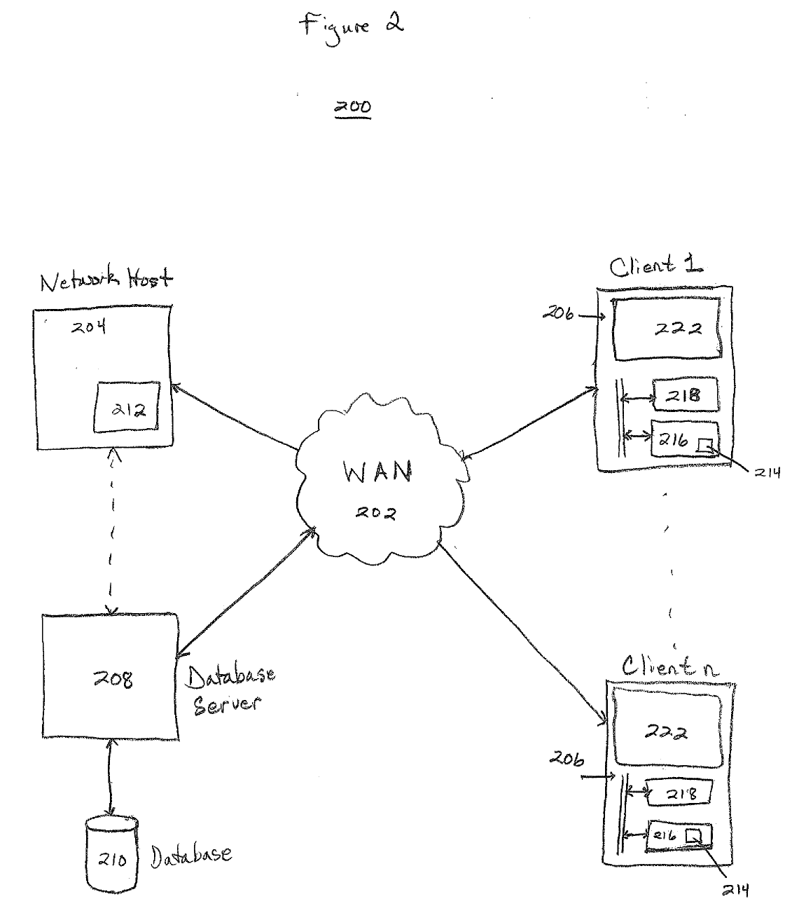

FIG. 2 is a block diagram illustrating a system 200 of anti-collusive vote weighting in accordance with the present disclosure. In an aspect, the system 200 may comprise a Wide Area Network (WAN) 202, a network host computer 204, a plurality of clients 206, a database server 208 and a database 210. The WAN may enable connectivity between the network host computer 204, the plurality of clients 206, the database server 208 and the database 210. The network host computer 204 may comprise a correlation application 212, which may be encoded on computer-readable media and configured for performing method 100 and other functions described herein. In the alternative, or in addition, each of the plurality of clients 206 may comprise a correlation program 214, which may also be encoded on computer-readable media and configured for performing the steps described herein. In yet another embodiment, some of the steps described herein may be performed by the correlation application 212 and other steps may be performed by the correlation program 214. The database server 208 and attached database 210 may be coupled to the network host computer 204 to store the database used in the method described herein. Alternatively, the database server 208 and/or database 210 may be connected to the WAN 202 and may be operable to be accessed by the network host computer 204 via the WAN 202.

The plurality of clients 206 may further comprise an internal hard disk 216 for storing the correlation program 214, a processor 218 for executing the correlation program 214 and/or performing other background tasks and an internal bus 220 for internally connecting the hard disk 216 and the processor 218. The hard disk 216 may also be configured to store the database described herein. The outputted voter score, may be displayed on the clients 206 via a display 222 in accordance with the compiled list of online information items.

The system and methods may be used in connection with determining whether voter collusion has occurred with respect to a given single information item. This may be accomplished by analyzing the vote histories of users who voted for the information item. A correlation table may provide the calculated correlation of vote histories between all of the users voting on the information item. Thus, a user will have a plurality of correlation values resulting from having his vote history correlated with every other user who votes on the information item. If, for example, user #1 and user #2's vote histories have a correlation above a threshold (i.e., 75%), then both user #1 and user #2 may have each of their votes reduced by a certain value by applying a lesser predetermined weight. The threshold may be selected, for example, based on empirical determinations as to when collusion is likely to result in the correlation value.

The reduced weight of user #1 and user #2's vote may also be provided as a function of the correlation value. Thus, the higher the correlation between vote histories, the greater the reduction in weight applied to the user's vote. If user #1 and user #2 is determined to have a correlation value of 85% and user #3 and user #4 is determined to have a correlation value of 75%, for example, then the weight of user #1 and user #2's votes may be reduced by 85% and the weight of user #3 and user #4's votes may be reduced by 75%. While the examples disclose reducing the weight by the correlation, any lesser or greater reductions in weight may be accomplished. In addition, the reduction in weight may not follow the correlation value linearly, but logarithmically or exponentially greater above a certain threshold.

Each user will have a plurality of correlation values associated with each of the other voters who voted for the information item. For example, if a threshold of 75% is provided, and user #1 is found to have a correlation value of 80% with user #2, 85% with user #3, and 20% with user #4, it is possible that collusion exists between users #1, #2 and #3. The value of user #1's vote may be reduced in accordance with the highest correlation value (80%) or a correlation between all three users #1, #2 and #3 may be recalculated and applied equally to each of them.

It is contemplated that certain of the users voting on an information item may have a limited voting history. For example, users who vote for the first time will have a 100% correlation with other first time voters. Moreover, users who do not have extensive voting histories are also susceptible to having higher correlation values, despite the fact that they may not be colluding with other users. It may thus be desirable to exclude first time users or users having limited voting histories from the weighting step. This may be done, for example, by looking at the users vote histories and requiring that the user have voted for a certain number of stories before correlating the vote histories for the users.

It is understood that the calculations described in relation to reducing the weight of a user's vote may be applied for increasing the weight of the user's vote. A second threshold may be provided and users having vote histories that are poorly correlated (i.e., under 5%) may have the weight of their votes increased. The extent to which the weight of a user's votes is increased may be an inverse linear, logarithmic, exponential or other relationship with the correlation values. Alternatively, the extent to which the weight of a user's vote is increased may be a flat rate below the second threshold value.

Having thus described embodiments of a method and system for anti-collusive vote weighting, it should be apparent to those skilled in the art that certain advantages of the within system have been achieved. It should also be appreciated that various modifications, adaptations, and alternative embodiments thereof may be made within the scope and spirit of the present invention. For example, a system operable over a wide area network has been illustrated, but it should be apparent that the inventive concepts described above would be equally applicable to systems operating over other networks.

What is claimed is:

1. An anti-collusive vote weighting system comprising:
a network interface disposed to receive voting data from a plurality of users, the voting data pertaining to information items;
a database comprising vote histories for the users, the vote histories associating each user with voting data;
a memory holding program instructions operable for:
compiling a list of information items ranked by the quantity of voting data received from the plurality of users above a predetermined threshold;
correlating the vote histories of two or more users for each one of the information items to obtain a correlation value associated for each one of the two or more users;
assigning a lesser predetermined weight to the voting data of users having correlation values above a first predetermined value; and
a processor, in communication with the memory and the network interface, configured for operating the program instructions.

2. The anti-collusive vote weighting system of claim 1, the memory further holding program instructions operable for aggregating the voting data from users associated with each one of the information items.

3. The anti-collusive vote weighting system of claim 2, the memory further holding program instructions operable for outputting an adjusted voter score for each one of the information items.

4. The anti-collusive vote weighting system of claim 1, wherein the list is pre-populated.

5. The anti-collusive vote weighting system of claim 1, wherein the list is generated by user submissions.

6. The anti-collusive vote weighting system of claim 1, wherein the list ranks information items from the highest quantity of voting data received to the lowest quantity of voting data received.

7. The anti-collusive vote weighting system of claim 1, wherein the program instructions further comprise instructions for identifying two or more information items concerning identical topics by analyzing any one or more of the title, contents or source of the information items.

8. The anti-collusive vote weighting system of claim 1, wherein the lesser predetermined weight assigned to voting data of each user is based on the correlation value associated with the user.

9. The anti-collusive vote weighting system of claim 1 further comprising assigning a greater predetermined weight to the voting data of the users having correlation values below a second predetermined value.

10. The anti-collusive vote weighting system of claim 9, wherein the greater predetermined weight assigned to the voting data of each user is based on the correlation value associated with the user.

11. Computer-readable media encoded with instructions operative to cause a computer to perform the steps of:
compiling information items ranked by the quantity of voting data received from a plurality of users;
correlating vote histories of two or more users for each one of the information items to obtain a correlation value for each one of the two or more users, representing a frequency with which the two or more users have provided identical votes for information items that are identical or having identical topics;
assigning a lesser predetermined weight to the voting data of users having correlation values above a first predetermined value, to provide a weighted ranking of the information items; and
providing an output for display of the information items organized according to the weighted ranking, thereby reducing impact of collaborative voting on ranking of the information items.

12. The computer-readable media of claim 11, further comprising selecting the information items to include in the ranked output.

13. The computer-readable media of claim 11, further comprising selecting the information items to include in the ranked output from information items submitted by users.

14. The computer-readable media of claim 11 further operative to provide the output for display of the information items organized in a list.

15. The computer-readable media of claim 14, wherein the list ranks information items from the highest quantity of voting data received to the lowest quantity of voting data received.

16. The computer-readable media of claim 11 further operative to perform identifying the information items having identical topics by analyzing any one or more of the title, contents or source of the information items.

17. The computer-readable media of claim 11 further operative to perform the step of assigning a greater predetermined weight to the voting data of the users having correlation values below a second predetermined value.

18. A method for reducing impact of collaborative user responses on data structures organized according to collective interest indicated by responses received from a plurality of clients, the method comprising:
compiling interest data for electronic information items at a server, the interest data compiled from responses originating from a plurality of clients;
correlating response histories of two or more accounts for each one of the information items to obtain a correlation score for each one of the two or more accounts, representing a degree to which the two or more accounts are sources of identical responses for information items that are substantially identical or that concern substantially identical topics;
weighting the interest data to reduce influence of responses received from the plurality of clients in inverse proportion to each accounts' correlation score; and
providing an output for display of the information items organized according to the weighted interest data at client display terminals, thereby reducing influence of collaborative voting on relative interest indicated in the display for the information items.

19. The method of claim 18, further comprising selecting the information items to include in the output, based on the interest data.

20. The method of claim 18, further comprising selecting the information items to include in the ranked output from information items submitted via the plurality of clients.

21. The method of claim 18, further comprising providing the output for display of the information items organized in a ranked list.

22. The method of claim 21, wherein the list ranks information items from a highest interest level indicated by the weighted interest data to a lowest interest level indicated by the weighted interest data.

23. The method of claim 18, further comprising identifying the information items having identical topics by analyzing any one or more of the title, contents or source of the information items.
